(19) United States
(12) Patent Application Publication
(10) Pub. No.: US 2009/0011940 A1
(43) Pub. Date: Jan. 8, 2009

(54) System and method for using a vacuum core high temperature superconducting resonator

(76) Inventor: Anthony Francis Issa, Orlando, FL (US)

Correspondence Address: MILBANK, TWEED, HADLEY & MCCLOY, 1 CHASE MANHATTAN PLAZA, NEW YORK, NY, 10005-1413, US

(21) Appl. No.: 12/214,655

(22) Filed: Jun. 20, 2008

Related U.S. Application Data
(60) Provisional application No. 60/936,506, filed on Jun. 20, 2007.
(60) Provisional application No. 61/004,373, filed on Nov. 27, 2007.

(51) Int. Cl. H01F 27/08; H01F 27/28

(52) U.S. Cl. 505/211; 336/55; 336/170

(57) ABSTRACT

A system for resonating. In one aspect, the system may include a temperature controlled, vacuum chamber. The chamber may include a primary superconductive coil having first and second ends and wrapped around a first non-conductive cylindrical form, where each of the first and second ends of the primary superconductive coil is coupled to a terminal of a driver, a secondary superconductive coil having first and second ends and wrapped around a second non-conductive cylindrical form, where a first end is coupled to a ground, and a tertiary superconductive coil having first and second ends and wrapped around a third non-conductive cylindrical form, where a first end is connected to a top load and a second end is coupled to the second end of the secondary superconductive coil. In one aspect, the top load is connected to an electrode, at least a portion of the electrode is located outside the chamber, and the first non-conductive cylindrical form at least partially surrounds the second non-conductive cylindrical form.

This application claims the benefit of provisional patent application Ser. No. 60/936,506, filed Jun. 20, 2007; and provisional patent application Ser. No. 61/004,373, filed Nov. 27, 2007, the entire contents of each of which are hereby incorporated by reference into the present disclosure. This application further hereby incorporates by reference U.S. non-provisional patent application Ser. No. 12/152,545 titled “System and Method for Forming and Controlling Electric Arcs,” filed May 15, 2008 and U.S. non-provisional patent application Ser. No. 12/152,525 titled “System and Method for Controlling an Electromagnetic Field Generator,” filed May 15, 2008.

### FIELD OF THE INVENTION

The present invention relates to a system and method for using a vacuum core high temperature superconducting resonator.

### BACKGROUND OF THE INVENTION

Various types of electromagnetic resonators for forming electrical discharges or arcs from an electromagnetic field generator are known. For example, one type of air core transformer known as a solid state Tesla coil (SSTC) may be capable of forming such electrical discharges. A SSTC may be a transformer that typically uses an alternating current power source and at least two coils to generate a high voltage at an electrode where electrical discharges may be formed.

### SUMMARY OF THE INVENTION

The present disclosure relates to a system for resonating. In one aspect, the system may include a temperature controlled, vacuum chamber containing at least a primary superconductive coil having first and second ends and wrapped around a first non-conductive cylindrical form, where each of the first and second ends of the primary superconductive coil is coupled to a terminal of a driver, a secondary superconductive coil having first and second ends and wrapped around a second non-conductive cylindrical form, where a first end is coupled to a ground, and a tertiary superconductive coil having first and second ends and wrapped around a third non-conductive cylindrical form, where a first end is connected to a top load and a second end is coupled to the second end of the secondary superconductive coil, wherein the top load is connected to an electrode, where at least a portion of the electrode is located outside the chamber, and wherein the first non-conductive cylindrical form at least partially surrounds the second non-conductive cylindrical form.

### BRIEF DESCRIPTION OF THE DRAWINGS

Features and other aspects of embodiments of the present invention are explained in the following description taken in conjunction with the accompanying drawings, wherein like references' numerals refer to like components, and wherein:

FIG. 1 illustrates an apparatus according to embodiments of the present invention;

FIG. 2 illustrates a top-level view of an apparatus according to embodiments of the present invention;

FIG. 3 illustrates an apparatus according to embodiments of the present invention;

The drawings are exemplary, not limiting.

### DETAILED DESCRIPTION

Various embodiments of the present invention will now be described in greater detail with reference to the drawings.

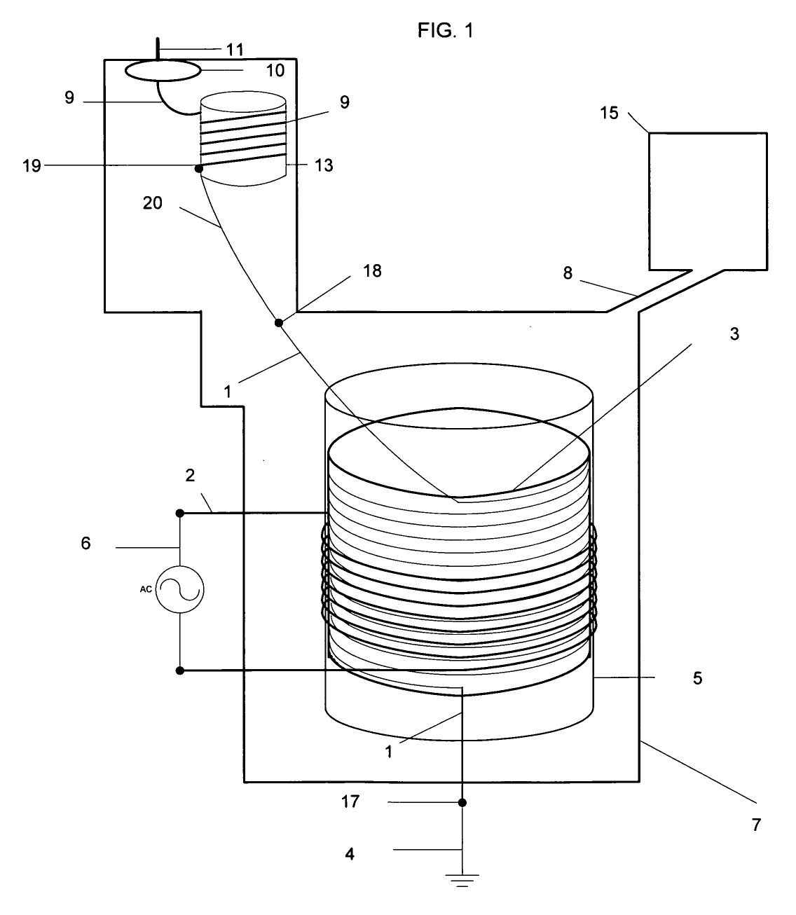

As shown in FIG. 1, one embodiment of the present invention may include a solid state alternating current driving system 6 for driving a desired waveform into primary coil 2. Primary coil 2 may be composed of a high temperature superconducting (“HTS”) tape, for example, Bi₂Sr₂Ca₁Cu₂Ox (BSCCO-2212). The superconducting tape may be surface coated or dipped, which may be beneficial to the skin effect as the superconducting region may be on the periphery of the conductor. In other aspects, other HTS tapes may include, for example, silver (Ag) sheathed (Bi,Pb,)2Sr₂Ca₂Cu₃O₁₀+x (Bi2223) powder in tube tape, for example, in a multifilamentary layout, which may reduce current degradation during the winding procedure.

In further aspects, secondary coil 1 may be helically wound on nonconductive tube 3. Nonconductive tube 5 may surround secondary coil 1. Driving primary coil 2 may be helically wound on nonconductive tube 5. Nonconductive tubes 3 and 5 may be made of, for example, ceramic, Teflon, or Kapton. The HTS primary coil 2, HTS secondary coil 1 and, HTS tertiary coil 9 may be insulated, for example, using kapton or Teflon tape or a polyvinyl formal (PVF) coating.

In another aspect, to further suppress corona, HTS primary coil 2, HTS secondary coil 1, and HTS tertiary coil 9 may be enclosed in an ultra-high vacuum (UHV) chamber 7, for example, a cryostat vacuum chamber. In aspects, ultra-high vacuum chamber 7 may be made of, for example, stainless steel. In other aspects, ultra-high vacuum chamber 7 may reach, for example, 10⁻⁷ Pascal or 100 nanopascals (˜10⁻⁹ torr). In further aspects, HTS primary coil 2 may be insulated from secondary coil 1, for example, using kapton or Teflon tape to prevent arc-over from occurring between primary coil 2 and secondary coil 1.

In another aspect, HTS tertiary coil 9 may be helically wound on non-conductive tube 13 and encased in an ultra high vacuum chamber 7. Cyrocooler 15 containing a cryogenic substance, for example, liquid nitrogen (LN2, 77K), may be used to cool ultra-high vacuum chamber 7 via cryogenic substance inlet/outlet 8. Cryogenic substance inlet/outlet 8 may allow the cryogenic substance to flow to and from the cryocooler 15 to the ultra-high vacuum chamber 7. Ultra-high vacuum chamber 7 may cool the HTS tape to superconducting temperatures, for example, 77 Kelvin.

In another aspect, liquid nitrogen (LN2, 77K) may be used as a coolant. The LN2 or other cryogenic substance may be stored in cyrocooler 15 and may be transported to the cyrostat that keeps all HTS coils at superconducting temperatures. Other cryogenic substances, for example, liquid neon (LNe, 27K), liquid hydrogen (LH2, 20K), or liquid helium (LHe, 4.2K), may also be used as coolants to extract the heat generated by AC hysteresis.

In another aspect, capacitive topload 10 may be connected to discharge electrode 11 and also to tertiary coil 9, which may be connected to secondary coil 1, which is connected to ground 4.

In one aspect, one or more transistors or paralleled transistors may pulse energy into a bridge system that turns a pulsed DC wave into a pulsed high frequency AC waveform. This may allow for bridge resonation to continue without interruption while modulated energy may be pulsed into the bridge.

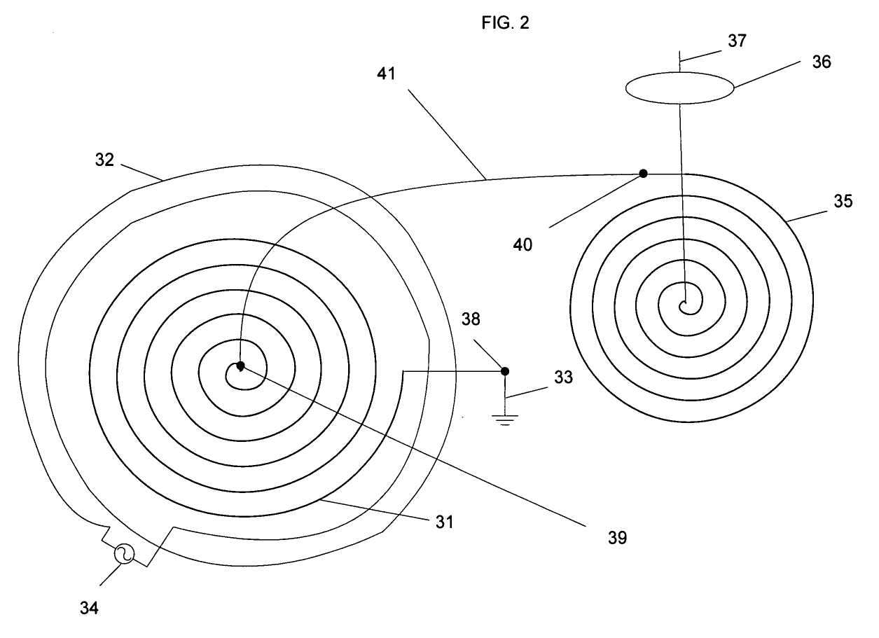

As shown in FIG. 2, in one aspect, one end 17 of the secondary coil 1 may be connected to ground 4. Another end 18 of the secondary coil 1 may be coupled by a conductor 20, for example, silver (Ag) tape, to outer winding 19 of tertiary coil 9. Such a design may be repeated with multiple tertiary coils and not limited to, for example, tertiary coil 9. In other aspects, the last tertiary coil that is connected in the series may be connected to top load 10, connected to discharge electrode 11.

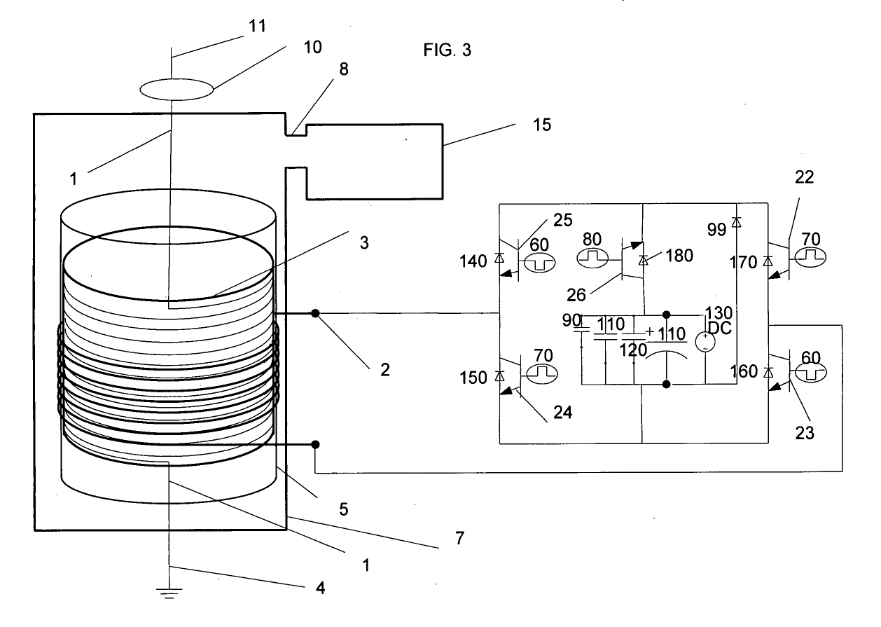

As shown in FIG. 3, in another aspect insulated gate bipolar transistors (IGBTs) 22, 23, 24, and 25 may be arranged in an H-bridge configuration with a Q-bridge IGBT 26 controlling the bus voltage between the DC supply 130 and the positive DC input of the H-bridge configuration. In other aspects, this solid state bridge system may drive a vacuum core high temperature superconducting resonator or other resonant system. In one aspect, the electromagnetic field generator may be a solid state Tesla coil having a primary HTS helical coil form 2, which may be wrapped around a nonconductive form 5, which may be made of, for example, ceramic, Teflon, or Kapton. Primary HTS helical coil 2 may induce a current into the secondary HTS helical coil 1, which may act as a Tesla resonator and be wrapped on a nonconductive form 3. In one aspect, secondary HTS helical coil 1 may be connected to toroidal top load 10, which in turn is connected to the discharge electrode 11.

In another aspect, when voltages ring up in the secondary coil 1, a voltage drop between ground 4 and the discharge electrode 11 may emit lightning, which for example, may be modulated to create sound waves. This may result in some electrons being ripped from air molecules around the discharge electrode 11, creating an arc or plasma formations around the discharge electrode 11. In further aspects, the resultant plasma may have power added or reduced, and in doing so, may make sound wave concussions. Power in the plasma may be added or reduced by the secondary HTS helical coil 1, which may receive its energy from primary HTS helical coil 2. Primary HTS helical coil 2 may receive its AC energy from an H-bridge including IGBTs 22, 23, 24, and 25. IGBTs 22, 23, 24, and 25 may receive their energy from DC source 130, which may be controlled by a signal 80, which may be a pulse width modulation (PWM) digital signal.

In another aspect, IGBTs 22 and 24 may receive and be controlled by signal 70 and IGBTs 23 and 25 may receive control signal 60. The signal 70 may switch IGBTs at or near the resonant frequency phase of the vacuum core HTS electromagnetic field generator such that the energy driven into the primary HTS helical coil 2 may move energy to the secondary HTS helical coil 1. In further aspects, when the secondary HTS coil 1 is highly energized and/or when the primary HTS coil 2 is in resonance with the secondary HTS helical coil 1, high peak current may damage IGBTs 22, 23, 24 and 25 unless IGBTs 22, 23, 24, and 25 are switched at the zero current crossings.

In another aspect, this window where IGBTs 22, 23, 24, and 25 may be switched, may limit the dead time controls over IGBTs 22, 23, 24, and 25 and the frequency at which they may switch. In further aspects, IGBT 26 may have no such limitations when, for example, high currents are present in the secondary HTS helical coil 1. In further aspects, the IGBT 26 may switch at any frequency or pulse width and may not be limited to the resonant frequency of the secondary HTS helical coil 1.

As shown in FIG. 3, in one aspect, if for example, the gate logic control signals 60 and 70 are zero (low), then the H bridge may no longer resonate and any extra electromagnetic energy inside the Tesla resonator and/or primary HTS helical coil 2 may flow back into the bridge system. Current then may be rectified via diodes 140, 150, 160, and 170. Energy may then flow through diode 180 to charge the DC bus capacitors 90, 100, 120, and 110. In effect, when IGBTs 22, 23, 24, and 25 are turned off, all the energy in the electrodynamic dimension may charge the DC bus line and the HTS helical resonator may be off or may no longer be in oscillation.

In further aspects, if the gate input logic 80 is at zero volts or is held low, IGBT 26 may be off and no power may travel from the DC bus capacitor 110 or from the DC power source 130. In one example, electrically turning off the IGBT 26 may be similar to removing the DC bus power supply 130 completely. The turning off of the IGBT 26 may not result in stopping the HTS helical resonator oscillations, but may result in a dip in the electrodynamic energy in the HTS helical resonator for the duration that IGBT 26 may be off. In further examples, when IGBT 26 may be off current may not flow and a freewheel diode 99 may be used so that current may flow from the bottom to the top of the H-bridge. This diode may protect the IGBT 26 from stray inductance loops, which in the case of high current, may result in very high peak voltages that may destroy IGBT 26.

In further aspects, this HTS resonator system may be able to handle frequencies on the order of, for example, 1 GHz or higher.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them) but only by the scope of claims.

What is claimed is:

1. A system for resonating, comprising:
a temperature controlled, vacuum chamber containing at least:
a primary superconductive coil having first and second ends and wrapped around a first non-conductive cylindrical form, where each of the first and second ends of the primary superconductive coil is coupled to a terminal of a driver;
a secondary superconductive coil having first and second ends and wrapped around a second non-conductive cylindrical form, where a first end is coupled to a ground; and
a tertiary superconductive coil having first and second ends and wrapped around a third non-conductive cylindrical form, where a first end is connected to a top load and a second end is coupled to the second end of the secondary superconductive coil;
wherein the top load is connected to an electrode, where at least a portion of the electrode is located outside the chamber, and
wherein the first non-conductive cylindrical form at least partially surrounds the second non-conductive cylindrical form.

2. The system of claim 1, further comprising a cryocooler coupled to the chamber for storing a cryogenic substance and providing the cryogenic substance to the chamber.

3. The system of claim 2, wherein the cryogenic substance is liquid nitrogen.

4. The system of claim 2, wherein the cryogenic substance is one of liquid neon, liquid hydrogen, and liquid helium.

5. The system of claim 1, wherein the first, second, and third non-conductive cylindrical forms are one of Teflon, Kapton, and polyvinyl formal (PVF) coating.

6. The system of claim 1, wherein the driver provides an AC waveform output to the primary superconductive coil and includes a plurality of transistors arranged in an H-bridge configuration.

7. The system of claim 1, wherein the second end of the secondary superconductive coil is coupled to the second end of the tertiary superconductive coil using silver tape.

8. The system of claim 1, wherein the primary, secondary, and tertiary superconductive coils are one of Bi₂Sr₂Ca₁Cu₂Ox (BSCCO-2212) and silver (Ag) sheathed (Bi,Pb,)2Sr₂Ca₂Cu₃O₁₀+x (Bi2223) powder in tube tape.

9. A system for resonating, comprising:
a temperature controlled, vacuum chamber containing at least:
a primary superconductive coil having first and second ends and wrapped around a first non-conductive cylindrical form, where each of the first and second ends of the primary superconductive coil is coupled to a terminal of a driver; and
a secondary superconductive coil having first and second ends and wrapped around a second non-conductive cylindrical form, where a first end is coupled to a ground and a second end is coupled to a top load;
wherein the top load is connected to an electrode, where at least a portion of the electrode is located outside the chamber, and
wherein the first non-conductive cylindrical form at least partially surrounds the second non-conductive cylindrical form.

10. The system of claim 9, further comprising a cryocooler coupled to the chamber for storing a cryogenic substance and providing the cryogenic substance to the chamber.

11. The system of claim 10, wherein the cryogenic substance is liquid nitrogen.

12. The system of claim 10, wherein the cryogenic substance is one of liquid neon, liquid hydrogen, and liquid helium.

13. The system of claim 10, wherein the first, second, and third non-conductive cylindrical forms are one of Teflon, Kapton, and polyvinyl formal (PVF) coating.

14. The system of claim 9, wherein the driver provides an AC waveform output to the primary superconductive coil and includes a plurality of transistors arranged in an H-bridge configuration.

15. The system of claim 9, wherein the primary and secondary superconductive coils are one of Bi₂Sr₂Ca₁Cu₂Ox (BSCCO-2212) and silver (Ag) sheathed (Bi,Pb,)2Sr₂Ca₂Cu₃O₁₀+x (Bi2223) powder in tube tape.

16. A method for resonating, comprising:
supplying an input signal to a drive circuit coupled to a primary superconductive coil wrapped around a first non-conductive cylindrical form that at least partially surrounds a second non-conductive cylindrical form;
automatically resonating a secondary superconductive coil wrapped around the second non-conductive cylindrical form; and
automatically generating an output signal at an electrode coupled to the secondary superconductive coil via a top load,
wherein the primary and secondary superconductive coils and the first and second non-conductive cylindrical forms are within a temperature controlled, vacuum chamber, and wherein at least a portion of the electrode is located outside the chamber.

17. The method of claim 16, wherein the secondary superconductive coil is coupled to the top load via a tertiary superconductive coil wrapped around a third non-conductive cylindrical form each within the temperature controlled, vacuum chamber.

18. The method of claim 16, further comprising the step of automatically circulating a cryogenic substance between a cryocooler and the chamber.

19. The method of claim 18, wherein the cryogenic substance is liquid nitrogen.

20. The method of claim 18, wherein the cryogenic substance is one of liquid neon, liquid hydrogen, and liquid helium.

21. A system for resonating, comprising:
a temperature controlled, vacuum chamber containing at least:
a primary superconductive pancake coil having first and second ends, where each of the first and second ends of the primary superconductive pancake coil is coupled to a terminal of a driver;
a secondary superconductive pancake coil having first and second ends, where a first end is coupled to a ground; and
a tertiary superconductive pancake coil having first and second ends, where a first end is connected to a top load and a second end is coupled to the second end of the secondary superconductive pancake coil; and
wherein the top load is connected to an electrode, where at least a portion of the electrode is located outside the chamber.

22. The system of claim 21, further comprising a cryocooler coupled to the chamber for storing a cryogenic substance and providing the cryogenic substance to the chamber.

23. The system of claim 22, wherein the cryogenic substance is liquid nitrogen.

24. The system of claim 22, wherein the cryogenic substance is one of liquid neon, liquid hydrogen, and liquid helium.

25. The system of claim 21, wherein the driver provides an AC waveform output to the primary superconductive coil and includes a plurality of transistors arranged in an H-bridge configuration.

26. The system of claim 21, wherein the second end of the secondary superconductive pancake coil is coupled to the second end of the tertiary superconductive coil using silver tape.

27. The system of claim 21, wherein the primary, secondary, and tertiary superconductive pancake coils are one of Bi₂Sr₂Ca₁Cu₂Ox (BSCCO-2212) and silver (Ag) sheathed (Bi,Pb,)2Sr₂Ca₂Cu₃O₁₀+x (Bi2223) powder in tube tape.

28. The system of claim 21, wherein the secondary superconductive pancake coil shares a common center with the primary superconductive pancake coil.

29. The system of claim 28, wherein the inner radius of the primary superconductive pancake coil is greater than the outer radius of the secondary superconductive pancake coil.
